(19) United States
(12) Patent Application Publication
(10) Pub. No.: US 2011/0034574 A1
(43) Pub. Date: Feb. 10, 2011

(54) SILICONE-CONTAINING POLYISOCYANURATE FOAM

(75) Inventor: Jens Cremer, Munich (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/935,621

(22) PCT Filed: Apr. 21, 2009
(86) PCT No.: PCT/EP2009/054694

§ 371 Date: Sep. 30, 2010

(30) Foreign Application Priority Data
Apr. 25, 2008 (DE) 10 2008 001 384.6

(51) Int. Cl. C08G 77/18; C08J 9/00

(52) U.S. Cl. 521/130; 521/154

(57) ABSTRACT

Silicone-containing polyurethane foams containing isocyanurate linkages are prepared from hyperbranched siloxanes having isocyanate groups or from hyperbranched siloxanes having isocyanate reactive groups and a polyisocyanate, the isocyanate groups being present in stoichiometric excess, in the presence of a trimerization catalyst. The foams are preparable at low densities and exhibit good flammability characteristics.

The invention relates to foamable compositions based on organosilicon compounds, to silicone-containing polyisocyanurate foams with low densities, and to processes for their preparation.

Despite the fact that in recent decades there has been no lack of intense research activities into improving the flame retardance properties of polymer foams, it has not yet proven possible to establish strongly flame-retarded PU foams on the market.

One relatively successful approach which has emerged to the production of flame-retarded polyurethane foams is polyisocyanurate chemistry. Production of such foams typically involves a reaction of polyisocyanates with compounds having hydrogen atoms that are reactive toward isocyanate groups, such as polypropylene glycols, with the isocyanate index being at least 180. In such reaction, in the presence of a trimerization catalyst, formation of the urethane structures is accompanied by formation of isocyanurate structures as well. The resulting polyisocyanurate (PIR) foams are, typically, closed-cell, rigid foams, which among all of the types of polyurethane foam exhibit the best fire properties in respect of fire retardance.

Generally speaking, in the production of rigid polyisocyanurate foams, not only blowing catalysts and gel catalysts, usually amines, but also trimerization catalysts are among the catalysts employed. Additionally, catalyst systems consisting of a mixture of different catalysts are found in the prior art. These rigid PIR foams are typically produced using physical and chemical blowing agents. Physical blowing agents used include, for example, chlorofluorocarbons (CFCs), hydrochlorofluorocarbons (HCFCs), hydrocarbons, and also liquid carbon dioxide, while chemical blowing agents used are principally water and carboxylic acids.

Despite the fact that the rigid PIR foams already have relatively good fire properties, there is still a great need for improvement, since high levels of added flame retardants are needed in order to obtain optimized fire retardance. Such flame retardants adversely affect the mechanical properties of the resulting foam, and, furthermore, are not always toxicologically benign.

It would therefore be desirable to have a rigid foam which is characterized by improved fire properties, has good mechanical properties with low foam densities, and can be used without the addition of flame retardants.

One such route to flame-retarded, PU foams is taken with the silicone-polyurethane foams. In such foams, the highly combustible polyol component that is used in standard PU foams is replaced by poorly combustible, OH-terminated siloxanes. Through the use of silicone-polyurethane copolymers, i.e., of polysiloxanes, which also contain polyurethane units and/or urea units, it is possible to develop fireproof foam materials of this kind which have new combinations of properties that are tailored precisely to the particular application.

Reference on this point may be made, for example, to EP 1485419 B1, which describes the preparation of silicone-polyurethane foams starting from alkylamino- or alkylhydroxy-terminated silicone oils and diisocyanates in what is called a “one-shot” process. Furthermore, DE 102006013416 A1 describes the preparation of silicone-PU foams from prepolymers which are prepared in a solvent-based operation on the basis of alkylamino- or alkylhydroxy-terminated silicone oils and diisocyanates.

A feature which unites the silicone-polyurethane foams that have been described to date is that they are prepared on the basis of siloxanes which are linear or have only very slight, but statistical, branching in the side chains. In view of this linear siloxane chain, the rise phase during foaming is not accompanied by an increase in molar mass, and so the increase in viscosity during the rise phase is relatively slow, meaning that the polymer matrix, even after the end of the blowing reaction, is generally slightly fluid, and, therefore, the fine cell structure may still collapse before curing of the foam is complete. Even if only a small fraction of the cell structure collapses in on itself, the result is a coarse and irregular cell distribution.

In order to counteract cell collapse when using linear polyol components, the struts connecting the individual foam cells must not fall below a critical diameter during the rise phase. Hence it is ensured that the still fluid polymatrix is able to counteract the threat of collapse of the foam structure. If, however, the desired foam density selected is too low, then the cell struts become increasingly thin during the rise phase until, finally, they become too flexible to stabilize the cell structure. Accordingly, in general, linear siloxanes result only in silicone-PU foams having densities of well above 100 kg/m³.

Hyperbranched polymers are already known and are discussed exhaustively, for example, in the review article by C. Gao, D. Yan; Prog. Polym. Sci., 2004, 24, 183-275, in relation to synthesis, properties, and applications. Hyperbranched polymers are a subset of dendritic macromolecules, and possess greater branching than conventionally branched polymers, which primarily have primary or secondary branches on a linear main chain. To date, for the synthesis of hyperbranched polymers, divergent synthesis methods have been employed, where a monomer possessing just two different kinds of functional groups that react with one another, but not with themselves, the functionality of the monomers being in total greater than two. Examples of suitable monomers are those which possess one functional group A and two functional groups B, i.e., a AB₂ monomer. In principle it is possible to use all monomers ABₓ where x>1. The use of ABₓ monomers in a monomolecular polymerization, however, is possible only when the A and B groups react with one another only when such reaction is desired in the polymer synthesis, in other words following addition of a catalyst or as a result of an increase in temperature. An alternative possibility is for hyperbranched polymers to be synthesized with two different types of monomer each having only one kind of functional groups, but in different numbers, such as A₃ and B₂ units, for example. Through a reaction of these two A₃ and B₂ types it is then possible in situ to obtain A₂B and AB₂ monomer blocks (di-molecular polymerization: generally with Aₓ and B_{y}, where x>1 and y>2). Processes of this kind are general knowledge and are described, for example, in U.S. Pat. No. 6,534,600.

The invention provides foamable compositions which comprise (A) hyperbranched siloxanes of the formula

V—(R²)ₚ₋ₘ([SiR₂O]₁—SiR₂R¹)ₘ (I)

optionally
(B) polyisocyanates
and also
(G) trimerization catalysts,
in which
V is a radical of value p,
R can be identical or different and is a monovalent, optionally substituted hydrocarbon radical,
R¹ can be identical or different and is a monovalent organic radical which has at least one isocyanate group, or is a group which is reactive with isocyanate radicals,
R² can be identical or different and represents monovalent radicals,
l is an integer greater than or equal to 1, preferably 1 to 1000, more preferably 5 to 500, more particularly 10 to 100,
p is an integer greater than or equal to 3, preferably 3 to 20, more preferably 3 or 4, and
m is an integer greater than or equal to 3, preferably 3 to 20, more preferably 3 to 4,
with the proviso that p is greater than or equal to m and, in the foamable composition, at least three isocyanate groups are present.

Examples of R are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl and the naphthyl radical; alkaryl radicals, such as o-, m-, p-tolyl radicals, xylyl radicals, and ethylphenyl radicals; aralkyl radicals, such as the benzyl radical, the α- and the β-phenylethyl radical.

Examples of substituted hydrocarbon radicals R are methoxymethylene radicals, ethoxymethylene radicals, dimethylaminomethylene and diethylaminomethylene.

Preferably radical R comprises monovalent, optionally substituted hydrocarbon radicals having 1 to 40 carbon atoms, more preferably hydrocarbon radicals having 1 to 30 carbon atoms, more particularly hydrocarbon radicals having 1 to 6 carbon atoms.

Radical R¹ preferably comprises those of the formula

—Yₐ-A-H (II),

or

—Yₐ-A-C(O)—NH—Z—NCO (III)

where
Y and Z independently of one another are divalent, optionally substituted hydrocarbon radicals which may be interrupted by heteroatoms,
A has the definition of —S—, —O— or —NR³—, where R³ is hydrogen atom or monovalent, optionally substituted hydrocarbon radical and
a is 0 or 1.

Radical R¹ is preferably of the formula (II).

Where radical R¹ in the siloxane (A) comprises exclusively radicals of the formula (II), the foamable preparations of the invention must comprise polyisocyanates (B).

Where radical R¹ in the siloxane (A) comprises, wholly or partly, radicals of the formula (III), the foamable preparations of the invention may comprise polyisocyanate (B), and this is preferred.

Examples of R³ are hydrogen atom and the examples given for radical R.

Preferably radical R³ is hydrogen atom.

Preferably radical A is —O—.

Examples of radicals Y and Z are, in each case independently of one another, ethylene, propylene, butylene, pentylene, hexamethylene, methyloxyethylene, tolylene, methylene-bis-phenylene, phenylene, naphthylene, cyclohexylene, and isophorone radicals.

Preferably Y comprises divalent, aliphatic, optionally —NCO-substituted hydrocarbon radicals which may be interrupted by heteroatoms, more preferably propylene and methyloxyethylene radicals, more particularly methyloxyethylene radicals.

Preferably Z comprises divalent, aromatic, optionally —NCO-substituted hydrocarbon radicals which may be interrupted by heteroatoms, more preferably toluenylene and methylene-bis-phenylene radicals, more particularly methylene-bis-phenylene radicals.

Most preferably, a, both in formula (II) and in formula (III), is 1.

Examples of radicals R² are hydrogen atom, organyloxy radicals, such as methoxy, ethoxy and phenoxy radicals, optionally substituted hydro-carbon radicals, such as, for example, the examples given for radical R, organyloxymethylene radicals, morpholinomethylene radicals, piperazinomethylene radicals, acrylamidomethylene radicals, dimethylaminomethylene radicals, diethylaminomethylene radicals, dibutylaminomethylene radicals, phenoxymethylene radicals, and methylmercaptomethylene radicals, and also siloxanyl radicals, which may be attached both via oxygen and via silicon to V.

Preferably radical R² comprises organyloxymethylene radicals, more preferably the methoxymethylene radical.

Examples of radical V are any desired polyvalent radicals known to date, such as, for example, polyvalent organic radicals, polyvalent silyl radicals, and boric acid radicals.

Preferably radical V comprises polyvalent organic radicals or polyvalent silyl radicals, more preferably polyvalent organic radicals.

If radical V comprises polyvalent silyl radicals, preference is given to SiO_{3/2} and SiO_{4/2}.

If radical V comprises polyvalent organic radicals, preference is given to polyvalent hydrocarbon radicals optionally substituted by nitrogen radicals and/or by oxygen radicals, and particular preference to those of the formula

W—[R⁴—R⁵—C(O)—R⁶—R_{c}⁷—]ₘ (IV)

where
W is a p-valent hydrocarbon radical, which may contain heteroatoms,
R⁴ may be identical or different and is a divalent, optionally substituted hydrocarbon radical,
R⁵ may be identical or different and is an optionally substituted hydrocarbon radical, —O— or —NR^{3′}—, where R^{3′} has one of the definitions stated above for R³,
R⁶ may be identical or different and is an optionally substituted hydrocarbon radical, —O— or —NR³″—, where R^{3″} has one of the definitions given above for R³,
R⁷ may be identical or different and is a divalent, optionally substituted hydrocarbon radical,
c is 0 or 1, and
p and m have one of the above definitions, with the proviso that p is greater than or equal to m.

Preferably W comprises trivalent, aliphatic or aromatic hydrocarbon radicals optionally containing heteroatoms, and more preferably comprises aromatic hydrocarbon radicals optionally containing heteroatoms.

Examples of radical W are 1,3,4-benzene, 1,3,5-cyanurate, and N,N,N′-biuret radicals.

Examples of radicals R⁴ and R⁷ are, in each case independently of one another, the radicals stated for Y and Z.

Preferably R⁴ comprises divalent, optionally substituted hydrocarbon radicals having 1 to 10 carbon atoms, more preferably phenylene radicals, tolylene radicals, and hexamethylene radicals, more particularly phenylene radicals.

Preferably radical R⁵ comprises —NH—.

Preferably radical R⁶ comprises —O—.

Preferably R⁷, to which, in the case of c=1, the groups ([SiR₂O]₁—SiR₂R¹) and also, optionally, R² attach, in accordance with formula (I), comprises divalent, aliphatic, optionally substituted hydrocarbon radicals having 1 to 6 carbon atoms, more preferably propylene and methyloxyethylene radicals, more particularly methyloxyethylene radicals. If c is 0, these groups attach directly to R⁶.

With particular preference, c is 1.

The hyperbranched siloxanes (A) used in accordance with the invention have an isocyanate content of preferably 0% to 25% by weight, more preferably 0% to 15% by weight.

The hyperbranched siloxanes (A) used in accordance with the invention have a viscosity of preferably 100 to 10 000 mPas, more preferably 500 to 5000 mPas, in each case at 25° C. and measured according to ASTM D 4283.

The hyperbranched siloxanes (A) of the invention can be prepared by processes which are commonplace in silicon chemistry.

In one preferred embodiment of the invention, the hyperbranched siloxanes (A), of the formula (I) used in accordance with the invention, with V as an organic radical, are prepared by reaction of linear α,ω-aminoalkyl-functionalized, α,ω-hydroxyalkyl-functionalized siloxanes or α,ω-hydroxy-functionalized siloxanes (A1) with polyisocyanates. This produces hyperbranched siloxanes (A) having radicals R¹ of the formula (III). If the intention is to obtain hyperbranched siloxanes (A) having radicals R¹ of the formula (III), then, in a further reaction step, the hyperbranched siloxanes having radicals R¹ of the formula (II) are reacted with further polyisocyanate, which is used in an excess, such that per mole of aminoalkyl radicals or hydroxyalkyl-functional radicals in the hyperbranched siloxanes having radicals R¹ of the formula (II) there is at least 1 mol, more particularly 2 to 20 mol, of isocyanate units used. The molar excess of isocyanates is preferably consumed at foam formation for the trimerization reaction to give isocyanurates.

In another preferred embodiment of the invention, hyperbranched siloxanes (A) of the formula (I) used in accordance with the invention, with V as a silyl radical, are obtained in a two-stage process, in which, first of all, linear α,ω-hydroxy-terminated siloxanes (A2) are reacted with a silane that is reactive toward (A2), such as trimethoxymethylsilane, for example, in a deficit amount relative to the siloxanes (A2). This produces hyperbranched siloxanes (A3) having radicals R¹ of the formula (II). If the intention is to obtain hyperbranched siloxanes (A) having radicals R¹ of the formula (III), then, in a further reaction step, the hyperbranched siloxanes having radicals R¹ of the formula (II) are reacted with further polyisocyanate, which is used in an excess, such that per mole of aminoalkyl radicals or hydroxyalkyl-functional radicals in the hyperbranched siloxanes having radicals R¹ of the formula (II), there is at least 1 mol, more particularly 2 to 20 mol, of isocyanate units used. The molar excess of isocyanates is preferably consumed at the foam formation for the trimerization reaction to give isocyanurates.

If desired, the hyperbranched siloxane (A3) may be functionalized prior to the reaction of the polyisocyanate. This functionalization takes place preferably with sila-cycles of the formulae

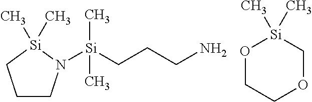

As optionally used polyisocyanates (B) it is possible to use all known organic compounds with two or more isocyanate groups. These can be aliphatic or aromatic isocyanates.

Preference is given to using, as polyisocyanates (B), those of the general formula

Q(NCO)_{b} (V)

where
Q is a b-functional, optionally substituted hydrocarbon radical and
b is an integer of at least 2, preferably from 2 to 10, more preferably 2 or 6, more particularly 2 to 5.

Preferably Q comprises optionally substituted hydrocarbon radicals having 4 to 30 carbon atoms, more preferably hydrocarbon radicals having 6 to 25 carbon atoms.

Examples of polyisocyanates (B) are diisocyanato-diphenylmethane (MDI), not only in the form of crude or technical MDI but also in the form of pure 4,4′ and/or 2,4′ isomers or compositions thereof, tolylene diisocyanate (TDI) in the form of its various regioisomers, diisocyanatonaphthalene (NDI), isophorone diisocyanate (IPDI), 1,3-bis(1-isocyanato-1-methyl-ethyl)benzene (TMXDI) or else hexamethylene diisocyanate (HDI), polymeric MDI (p-MDI), triphenylmethane triisocyanate or biuret trimers or isocyanurate trimers of the abovementioned isocyanates.

The polyisocyanates (B) used in accordance with the invention preferably comprise polymeric MDI of the formula

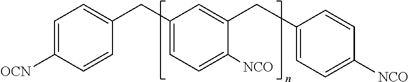

where n is 0 to 8. Polymeric MDI is obtained, for example, in the production of diphenylmethane diisocyanate, and generally is a mixture of difunctional MDI and various higher molecular mass MDI oligomers having a higher functionality.

The polyisocyanates (B) may be the same ones which may be used in preparing the siloxanes (A), in particular when the process is a two-stage preparation process. In that case, if desired, polyisocyanate may be used in excess in the preparation of the siloxanes (A) of the formula (I), with R¹ being the same as those of the formula (III), and the resulting mixture may advantageously be used further for preparing the composition of the invention.

Where the compositions of the invention comprise polyisocyanates (B), the amounts in question are preferably 0.1 to 150 parts by weight, more preferably 10 to 120 parts by weight, more particularly 20 to 100 parts by weight, based in each case on 100 parts by weight of hyperbranched siloxane (A).

The compositions of the invention preferably comprise polyisocyanates (B).

Further to the siloxanes (A), trimerization catalysts (G), and, if desired, polyisocyanates (B), the compositions of the invention may comprise further substances, such as, for example, fillers (C), emulsifiers (D), physical blowing agents (E), catalysts which accelerate foam formation (F), chemical blowing agents (H), and additives (I).

If fillers (C) are used, the fillers in question may be all nonreinforcing fillers, i.e., fillers having a BET surface area of up to 50 m²/g, such as chalk, or reinforcing fillers, i.e., fillers having a BET surface area of at least 50 m²/g, such as carbon black, precipitated silica or fumed silica. In particular both hydrophobic and hydrophilic fumed silicas represent a preferred filler. One particularly preferred embodiment of the invention uses a hydrophobic fumed silica whose surface has been modified with trimethylsilyl groups. The fillers (C) that are used—more particularly fumed silicas—may take on a variety of functions. Thus they may be used to adjust the viscosity of the foamable mixture. In particular, however, they are able to take on a “support function” in the course of foaming, and thus lead to foams having a better foam structure. Finally, the mechanical properties of the resultant foams may also be decisively improved through the use of fillers (C)—especially through the use of fumed silica. In addition, expandable graphite may also be added as filler (C).

If the compositions of the invention comprise fillers (C), the amounts in question are preferably 0.1 to 30 parts by weight, more preferably 0.1 to 20 parts by weight, more particularly 0.1 to 15 parts by weight, based in each case on 100 parts by weight of siloxane (A).

The compositions of the invention preferably comprise fillers (C).

In many cases it is of advantage to add emulsifiers (D) to the foamable compositions. As suitable emulsifiers (D), which also serve as foam stabilizers, it is possible, for example, to use all commercial silicone oligomers that are modified with polyether side chains and that are also used in producing conventional polyurethane foams.

If emulsifiers (D) are used, the amounts in question are preferably up to 6% by weight, more preferably from 0.3% to 3% by weight, based in each case on the total weight of the foamable compositions.

The compositions of the invention preferably comprise no emulsifiers (D).

The compositions may also comprise compounds (E) which are able to act as physical blowing agents. As constituent (E) it is preferred to use low molecular mass hydrocarbons such as, for example, n-propane, n-butane, n-pentane or cyclopentane, dimethyl ether, fluorinated hydrocarbons such as 1,1-difluoroethane or 1,1,1,2-tetrafluoroethane or CO₂. In this case the production of foam may if desired take place exclusively by means of the physical blowing agents (E). Usually, however, the formation of foam takes place through an additional reaction of the isocyanate-functional components in the composition of the invention with the chemical blowing agent component (H). Consequently, the amount of physical blowing agent (E) used is reduced in order thus to obtain foams having a relatively low density.

Component (E) more preferably comprises low molecular mass hydrocarbons, in particular n-pentane.

If the compositions of the invention comprise constituent (E), the amounts in question are from preferably 0.1 to 30 parts by weight, more preferably 0.1 to 20 parts by weight, more particularly 0.1 to 15 parts by weight, based in each case on 100 parts by weight of siloxane (A).

The compositions of the invention preferably comprise physical blowing agent (E).

Moreover, the foamable compositions of the invention may comprise further catalysts (F) which accelerate the foam formation by means of the chemical blowing agents (H). Suitable catalysts (F) include organotin compounds. Examples are dibutyltin dilaurate, dioctyltin dilaurate, dibutyltin diacetate, dibutyltin dioctoate or dibutyltin bis(dodecylmercaptide). Moreover, tin-free catalysts (F) are contemplated as well, for example, heavy-metal compounds or amines. An example of tin-free catalysts is iron(III) acetylacetonate, zinc(II) octoate, zirconium(IV) acetylacetonate, bismuth(III) neodecanoate. Examples of amines are triethylamine, tributylamine, 1,4-diazabicyclo[2.2.2]octane, N,N-bis(N,N-dimethyl-2-aminoethyl)methylamine, N,N-dimethylcyclohexylamine, N,N-dimethylphenylamine, bis-N,N-dimethylaminoethyl ether, N,N-dimethyl-2-aminoethanol, N,N-dimethylaminopyridine, N,N,N′,N″,N″-pentamethyldiethylenetriamine, 1,5-diazabicyclo[4.3.0]non-5-ene, 1,8-diazabicyclo[5.4.0]-undec-7-ene, N-ethylmorpholine or N,N′-dimethylaminopyridine.

Catalyst (F) preferably comprises amines, more preferably N,N,N′,N″,N″-pentamethyldiethylenetriamine.

The catalysts (F) may be used individually or as mixture. If desired, the catalysts used in the preparation of the siloxanes (A) may also serve simultaneously as catalysts (F) for foam formation.

If catalyst (F) is used, the amounts in question are from preferably 0.1% to 6.0% by weight, more preferably from 0.3% to 4.0% by weight, based in each case on the total weight of the foamable composition of the invention.

The compositions of the invention preferably comprise catalysts (F) if chemical blowing agents (H) are used.

The foamable compositions of the invention comprise trimerization catalysts (G) which initiate and accelerate the trimerization of isocyanate groups to isocyanurate groups.

Examples of trimerization catalysts (G) are ammonium, alkali metal salts or alkaline earth metal salts of carboxylic acid salts, such as, for instance, potassium formate, potassium acetate, potassium 2-ethylhexanoate, ammonium formate, ammonium acetate, ammonium 2-ethylhexanoate, 1-(N,N,N-trimethylammonio)propan-2-ol formate, and 1-(N,N,N-trimethylammonio)propan-2-ol 2-ethylhexanoate.

As component (G) it is preferred to use salts of carboxylic acids, more preferably salts of carboxylic acids having 1 to 20 carbon atoms. The carboxylic acids in question may be linear or branched, substituted or unsubstituted, saturated or unsaturated aliphatic or aromatic carboxylic acids.

Where trimerization catalyst (G) comprises carboxylic acid salts, potassium salts of carboxylic acids are preferred, more particularly potassium 2-ethylhexanoate.

The catalysts (G) may be used individually or as a mixture. Possibly they may be used in a mixture with one or more catalysts (F).

Catalyst (G) is used in amounts of preferably 0.1% to 10.0% by weight, more preferably from 0.3% to 6.0% by weight, based in each case on the total weight of the foamable composition of the invention.

As chemical blowing agents (H) it is possible in principle for not only water but also all compounds having preferably at least one isocyanate-reactive function to be used.

Examples of constituent (H) are aminoalkyl- or hydroxy-functional siloxanes other than component (A), monomeric alcohols, monomeric diols such as glycol, propanediol and butanediol, monomeric oligools such as pentaerythritol or trihydroxymethylethane, oligomeric or polymeric alcohols having one, two or more hydroxyl groups such as ethylene glycols or propylene glycols, water, monomeric amines having one, two or more amine functions such as ethylenediamine, hexamethylenediamine, and also oligomeric or polymeric amines having one, two or more amine functions.

If constituent (H) is used, it preferably comprises hydroxy compounds, with water being particularly preferred.

Where constituent (H) is water, the water involved may be of any kind, such as natural waters and chemical waters, for example, and water (H) may be liquid or gaseous, including atmospheric moisture.

If constituent (H) is used, the amounts are preferably 0.1 to 20 parts by weight, more preferably from 0.1 to 15 parts by weight, more particularly from 0.1 to 10 parts by weight, based in each case on 100 parts by weight of siloxane (A).

The compositions of the invention preferably comprise constituent (H).

As additives (I), furthermore, all additives which have, hitherto, also been used in foam-forming compositions may be used. Examples of additives (I) are cell regulators, thixotropic agents, plasticizers and dyes. In order to improve the fire resistance, moreover, flame retardants may be added to the foamable compositions, examples being phosphorus-containing compounds, especially phosphates and phosphonates, and also halogenated polyesters and polyols or chlorinated paraffins.

If additives (I) are used, the amounts involved are from preferably 0.1 to 30 parts by weight, more preferably from 0.1 to 20 parts by weight, more particularly from 0.1 to 15 parts by weight, based in each case on 100 parts by weight of siloxane (A).

The compositions of the invention preferably comprise additives (I).

With regard to the components used in accordance with the invention, the components in question may in each case be one kind of such a component or else a mixture of at least two kinds of a respective component.

Preferably the compositions of the invention are those comprising

(A) siloxanes of the formula (I),
optionally
(B) polyisocyanates,
optionally
(C) fillers,
optionally
(D) emulsifiers,
optionally
(E) physical blowing agents,
optionally
(F) catalysts which accelerate foam formation,
(G) trimerization catalysts,
optionally
(H) chemical blowing agents, and
optionally
(I) additives,
the compositions of the invention having at least three isocyanate groups as well as at least one blowing agent selected from components (E) and (H), preferably at least (E), in particular (E) in combination with (H).

Aside from components (A) to (I), the compositions of the invention preferably comprise no further constituents.

The compositions of the invention can be prepared by any desired processes known per se, such as simple mixing of the individual components, in which case premixes of individual constituents may also be prepared. Both 1-component systems and 2-component systems may be prepared.

Where the compositions of the invention are provided in the form of 2-component systems, which is preferred, the two components of the foamable composition of the invention may comprise all of the constituents in any desired combinations and proportions, with the proviso that one component does not simultaneously comprise isocyanate-functional components and trimerization catalyst (G) and also chemical blowing agent (H).

Thus, for example, to prepare the composition of the invention, preferably a mixture comprising constituent (A), optionally constituent (B), optionally constituent (C), optionally constituent (D), optionally constituent (E) and optionally constituent (I) is prepared, as component 1, and also a component 2 comprising constituent (G), optionally constituent (F), and optionally constituent (H), which are then mixed with one another to produce the foam of the invention.

It is, however, also possible to prepare the composition of the invention by mixing all of the constituents with one another in one step, which is technically difficult to perform and is consequently not preferred.

The compositions of the invention are preferably liquid to highly viscous and have a viscosity of preferably 250 to 10 000 mPas, more preferably 500 to 5000 mPas in each case at 25° C. and measured according to ASTM D 4283.

The compositions of the invention serve preferably for the production of foams, more preferably of rigid foams.

The present invention further provides a process for preparing silicone-containing polyisocyanurate foams, characterized in that hyperbranched siloxanes (A), optionally polyisocyanate (B) and trimerization catalyst (G) and also at least one blowing agent are mixed and caused to react.

In one preferred embodiment of the process of the invention, hyperbranched siloxane (A), polyisocyanate (B) and trimerization catalyst (G) and also at least one blowing agent are mixed and caused to react.

In one particularly preferred embodiment of the process of the invention, hyperbranched siloxane (A), polyisocyanate (B), physical blowing agent (E), catalyst (F), trimerization catalyst (G), and chemical blowing agent (H) are mixed and caused to react.

In one especially preferred embodiment of the process of the invention, first of all, hyperbranched siloxane (A), polyisocyanate (B), physical blowing agent (E), optionally fillers (C), and optionally additives (I) are premixed, and then are combined with a mixture consisting of catalyst (F), trimerization catalyst (G), and chemical blowing agent (H), and caused to react.

The process of the invention is carried out at starting temperatures of preferably 0 to 100° C., more preferably 10 to 40° C., more particularly 15 to 30° C. The heat produced during the reaction preferably remains in the system and contributes to foam formation. In the process of the invention, reaction temperatures of up to preferably 50 to 150° C. are attained.

The process of the invention is carried out preferably under the pressure of the surrounding atmosphere, in other words about 900 to 1100 hPa.

The process of the invention releases preferably gaseous components such as, for example, CO₂ and gaseous pentane which are largely responsible for the development of the foam structure according to the invention.

The invention further provides foams preparable by reacting hyperbranched siloxanes (A), optionally polyisocyanate (B) and trimerization catalyst (G) with at least one blowing agent.

The foams of the invention also have isocyanurate structures in addition to urethane structures.

The foams of the invention are notable for a fine, closed-cell foam structure, have excellent mechanical properties and have stable shapes and are not flexible.

The foams of the invention have a density of preferably 10 to 500 kg/m³, more preferably 15 to 300 kg/m³, more particularly 20 to 200 kg/m³ determined in each case at 25° C. and 1013 hPa.

The foams of the invention may have both a closed-cell and an open-cell structure.

The foams of the invention can be used everywhere polyisocyanurate foams have been used to date. More particularly they are suitable for thermal insulation, and sound insulation.

The foamable compositions of the invention have the advantage that they can be processed in a very simple way and using the techniques known to date from PU technology.

Furthermore, the compositions of the invention have the advantage that they can be prepared with starting materials that are readily available commercially.

The compositions of the invention have the advantage, moreover, that they are easy to process and can be prepared at low viscosity.

The compositions of the invention have the advantage that silicone rigid polyisocyanurate foams having low densities may be prepared.

The process of the invention for preparing polyisocyanurate foams has the advantage that it is easy to carry out.

The foams of the invention have the advantage, furthermore, that they are rigid and of extremely low flammability.

Furthermore, the foams of the invention have the advantage that they have high mechanical strengths, in particular in combination with low foam densities.

In the examples below, all parts and percentage data, unless indicated otherwise, are by weight. Unless indicated otherwise, the examples below are carried out under the pressure of the surrounding atmosphere, in other words at about 1000 hPa, and at room temperature, in other words about 20° C., or at a temperature which comes about when the reactants are combined at room temperature without additional heating or cooling. All of the viscosity data given in the examples are intended to be based on a temperature of 25° C.

In the examples, the following ingredients were used:

pMDI: polymeric MDI having a functionality of 2.9 (available commercially under the name Lupranat® M70R from BASF SE, D-Ludwigshafen);
Silicone emulsifier: polydimethylsiloxane-polyethylene oxide copolymer (available commercially under the name DABCO® 5598 from Air Products GmbH, D-Hamburg);
Amine catalyst: N,N,N′, N″,N″-pentamethyldiethylenetriamine;
Trimerization catalyst: potassium 2-ethylhexanoate, 75% strength by weight in diethylene glycol.

### INVENTIVE EXAMPLE 1

600.00 g of a linear organopolysiloxane of the formula HO—(CH₂)₂—O—(CH₂)—[Si (CH₃)₂—O]₁₄Si(CH₃)₂—(CH₂)—O—(CH₂)₂—OH and 63.0 g of pMDI were reacted under an inert gas atmosphere in 1000 ml of absolute acetone. The reaction was catalyzed with 20 mg of tin(II) 2-ethylhexanoate and stirred at 50° C. for 1 hour. After the end of reaction, the reaction mixture was then admixed with 20 mg of benzoyl chloride and freed from the solvent under a pressure of 10 mbar. This gave 663 g of a yellowish, hyperbranched, viscous siloxane as the pure substance.

66.3 g of the hyperbranched siloxane obtained were processed first with 33.7 g of pMDI and 1.20 g of silicone emulsifier and 12.0 g of n-pentane, using a high-speed KPG stirrer, to give a homogeneous emulsion. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 70 kg/m³.

### INVENTIVE EXAMPLE 2

66.3 g of the hyperbranched siloxane obtained from example 1 were processed first with 33.7 g of pMDI and 12.0 g of n-pentane, using a high-speed KPG stirrer, to give a homogeneous emulsion. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 70 kg/m³.

### INVENTIVE EXAMPLE 3

66.3 g of the hyperbranched siloxane obtained from example 1 were processed first with 33.7 g of pMDI and 14.0 g of n-pentane, using a high-speed KPG stirrer, to give a homogeneous emulsion. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 60 kg/m³.

### INVENTIVE EXAMPLE 4

66.3 g of the hyperbranched siloxane obtained from example 1 were processed first with 33.7 g of pMDI and 12.0 g of n-pentane, using a high-speed KPG stirrer, to give a homogeneous emulsion. Subsequently a mixture consisting of 0.20 g of water, 0.20 g of amine catalyst, and 2.80 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 60 kg/m³.

### INVENTIVE EXAMPLE 5

66.3 g of the hyperbranched siloxane obtained from example 1 were processed first with 53.7 g of pMDI and 1.20 g of silicone emulsifier and 12.0 g of n-pentane, using a high-speed KPG stirrer, to give a homogeneous emulsion. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 50 kg/m³.

### INVENTIVE EXAMPLE 6

90.00 g of a linear organopolysiloxane of the formula HO—(CH₂)₂—O—(CH₂)—[Si(CH₃)₂—O]₁₄Si(CH₃)₂—(CH₂)—O—(CH₂)₂—OH and 60.00 g of pMDI were reacted under an inert gas atmosphere (argon or nitrogen) in 200 ml of absolute acetone. The reaction was catalyzed with 30 mg of tin(II) 2-ethylhexanoate and stirred at 50° C. for 1 hour. After the end of reaction, the reaction mixture was then admixed with 30 mg of benzoyl chloride and freed from the solvent under a pressure of 10 mbar.

100.0 g of the resulting reaction product were processed to a homogeneous emulsion, following addition of 1.20 g of silicone emulsifier and 12.0 g of n-pentane, using a high-speed KPG stirrer. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 70 kg/m³.

### INVENTIVE EXAMPLE 7

60.00 g of an anhydrous, linear siloxane of the formula HO—[Si(CH₃)₂—O]₁₄Si(CH₃)₂—OH were first reacted with 3.20 g of (methylcarbamatomethyl)trimethoxysilaneat 60° C. and 10 mbar for 30 minutes in the presence of 100 ppm of lithium methoxide as catalyst. Subsequently 7.20 g of 2,2-dimethyl-2-sila-1,4-dioxacyclohexane were added, and stirring was continued at 60° C. for 30 minutes. After the end of reaction, the hyperbranched siloxane was neutralized with 100 ppm of acetic acid and was freed from byproducts at 10 mbar and 60° C. for 15 minutes. It was then taken up in 100 ml of absolute acetone and admixed with 40.0 g of pMDI. The resulting reaction mixture was then stirred for 30 min at 50° C. in the presence of 20 mg of tin(II) 2-ethylhexanoate as catalyst, the hydroxyl groups of the organosiloxane being fully consumed by reaction. Subsequently, the product was admixed with 30 mg of benzoyl chloride and was freed from the solvent under a pressure of 10 mbar.

60.0 g of the resulting reaction mixture were processed to a homogeneous emulsion with addition of 1.20 g of silicone emulsifier and 12.0 g of n-pentane, using a high-speed KPG stirrer. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 70 kg/m³.

### INVENTIVE EXAMPLE 8

60.00 g of an anhydrous, linear siloxane of the formula HO—[Si(CH₃)₂—O]₁₄Si(CH₃)₂—OH were first reacted with 3.20 g of (methylcarbamatomethyl)trimethoxysilane at 60° C. and 10 mbar in the presence of 100 ppm of lithium methoxide as catalyst. Subsequently 7.20 g of 2,2-dimethyl-2-sila-1,4-dioxacyclohexane were added, and stirring was carried out at 60° C. for 30 minutes. After the end of reaction, the hyperbranched siloxane was neutralized with 100 ppm of acetic acid and was freed from byproducts at 10 mbar and 60° C. for 15 minutes.

60.0 g of the resulting reaction mixture were first processed to a homogeneous emulsion with 40.0 g of pMDI and 1.20 g of silicone emulsifier and 12.0 g of n-pentane, using a high-speed KPG stirrer. Subsequently a mixture consisting of 0.20 g of water, 0.20 g of amine catalyst, and 1.40 g of trimerization catalyst was added rapidly and again emulsified by means of a high-speed KPG stirrer to give a homogeneous mixture. After approximately 10 seconds, an exothermic reaction began, with production of foam. Foam formation was over after a further approximately 90 seconds. The result was a rigid yellow foam having a density of 100 kg/m³.

1.-10. (canceled)

11. A foamable composition comprising hyperbranched siloxanes (A) of the formula
V—(R²)ₚ₋ₘ([SiR₂O]₁—SiR₂R¹)ₘ (I),
optionally one or more polyisocyanates (B), and
at least one trimerization catalyst (G)
in which
V is a radical of valence p,
R are identical or different monovalent, optionally substituted hydrocarbon radicals,
R¹ are identical or different monovalent organic radicals which have at least one isocyanate group or are groups reactive with isocyanate radicals,
R² are identical or different and are monovalent radicals,
l is an integer greater than or equal to 1,
p is an integer greater than or equal to 3, and
m is an integer greater than or equal to 3,
with the proviso that p is greater than or equal to m and, in the foamable composition, at least three isocyanate groups are present between the hyperbranched siloxanes A and optional polyisocyanates B.

12. The foamable composition of claim 11, wherein R¹ is a radical of the formulae
—Yₐ-A-H (II),
or
—Yₐ-A-C(O)—NH—Z—NCO (III)
where
Y and Z independently of one another are divalent, optionally substituted hydrocarbon radicals which may be interrupted by heteroatoms,
A is —S—, —O— or —NR³—, wherein R³ is a hydrogen atom or a monovalent, optionally substituted hydrocarbon radical, and
a is 0 or 1.

13. The foamable composition of claim 11, wherein a is 1.

14. The foamable composition of claim 12, wherein a is 1.

15. The foamable composition of claim 11, wherein radical V is a polyvalent organic radical or polyvalent silyl radical.

16. The foamable composition of claim 11, wherein the trimerization catalyst (G) comprises a carboxylic acid salt.

17. The foamable composition of claim 11, comprising
(A) siloxanes of the formula (I),
(B) optionally polyisocyanates,
(C) optionally fillers,
(D) optionally emulsifiers,
(E) optionally one or more physical blowing agents,
(F) optionally a catalyst which accelerates foam formation,
(G) at least one trimerization catalyst,
(H) optionally chemical blowing agents, and
(I) optionally further additives,
the composition of the invention having at least three isocyanate groups as well as at least one blowing agent selected from components (E) and (H).

18. A process for preparing a silicone-containing polyurethane foam, characterized in that hyperbranched siloxanes (A), optionally polyisocyanate (B) and trimerization catalyst (G) and also at least one blowing agent are mixed and caused to react.

19. A foam prepared by reacting hyperbranched siloxanes (A), optionally polyisocyanate (B) and trimerization catalyst (G) and also at least one blowing agent.

20. The foam of claim 19, having a density of 10 to 500 kg/m³ measured at 25° C. and 1013 hPa.

21. The foam of claim 20, which is a hard foam.

22. The foam of claim 19, having a density of less than 100 Kg/m³.
